(19) United States
(12) Patent Application Publication
(10) Pub. No.: US 2009/0265612 A1
(43) Pub. Date: Oct. 22, 2009

(54) METHODS, APPARATUSES, AND COMPUTER PROGRAM PRODUCTS FOR SPECIFYING CONTENT OF ELECTRONIC MAIL MESSAGES USING A MAIL MARKUP LANGUAGE

(75) Inventor: Edward Austin Cheney, Haltom City, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Travelocity.com LP

(21) Appl. No.: 12/425,524

(22) Filed: Apr. 17, 2009

Related U.S. Application Data
(60) Provisional application No. 61/045,869, filed on Apr. 17, 2008.

(51) Int. Cl. G06F 17/00; G06F 15/16; H04L 9/32

(52) U.S. Cl. 715/234; 709/206; 713/156

(57) ABSTRACT

A method, apparatus, and computer program product are provided for specifying content of electronic mail messages using a mail markup language. A method may include receiving content for inclusion in an electronic mail message. The method may further include receiving an indication of a formatting for at least a portion of the content. The method may additionally include adding the received content to the electronic mail message. The method may also include specifying the format of the electronic mail message based at least in part upon the received indication of formatting using a plurality of tags in accordance with a mail markup language. Corresponding computer program products and apparatuses are also provided.

### CROSS-REFERENCE TO RELATED APPLICATION

This application claims the benefit of U.S. Provisional Application No. 61/045,869, filed Apr. 17, 2008.

### TECHNOLOGICAL FIELD

Embodiments of the present invention relate generally to electronic mail message technology and, more particularly, relate to methods, apparatuses, and computer program products for specifying content of electronic mail messages using a mail markup language.

### BACKGROUND

The modern computing era has brought about a tremendous expansion in the use of electronic mail (email). In this regard, the evolution of computing devices and computing networks has ushered the rise of email as a ubiquitous, and in some cases preferred, communication medium. Expanded availability of enhanced data-capable mobile networks and the advent of affordable email-capable smart phones have enabled individuals to even check and send email on the go. This widespread access to and use of email services, along with the negligible cost of sending email, has resulted in the evolution of email into a medium of communication used for personal communications with friends and family, business correspondence, and even as a new mode of advertising.

However, heretofore specifying content of email messages, and in particular specifying a format for the content, has been problematic. In this regard, there has not existed any markup language specifically tailored to requirements and uses of the email medium. In particular, existing methods of specifying content do not provide tools for defining complex content layouts and enabling users to take full advantage of the convenience of the email medium. Instead, previous attempts to more fully define content of an email message have sought to adapt preexisting technologies and/or standards that are foreign to the electronic mail medium. In this regard, some attempts have been made to utilize preexisting standards for the communication medium of hypertext transfer protocol (HTTP) that were designed for websites. However, such preexisting standards used for defining website content do not adequately facilitate specifying content for the electronic mail medium.

Accordingly, it may be desirable to provide systems, methods, apparatuses, and computer program products for specifying content of electronic mail messages using a novel mail markup language tailored to the electronic mail medium.

### BRIEF SUMMARY OF SOME EXAMPLES OF THE INVENTION

A method, apparatus, and computer program product are therefore provided for specifying content of electronic mail messages using a mail markup language. In this regard, a method, apparatus, and computer program product are provided that may provide several advantages to computing devices and computing device users. Embodiments of the invention provide a mail markup language tailored to the electronic mail medium that may enable users to fully specify rich formatting for an electronic mail message. Embodiments of the invention further provide methods, apparatuses, and computer program products for sending and receiving electronic mail messages with a format specified in accordance with a mail markup language.

In a first exemplary embodiment, a method for specifying a format of an electronic mail message using a mail markup language is provided. The method of this embodiment includes receiving content for inclusion in the electronic mail message. The method of this embodiment further includes receiving an indication of formatting for at least a portion of the content. The method of this embodiment also includes adding the received content to the electronic mail message. The method of this embodiment additionally includes specifying the format of the electronic mail message based at least in part upon the received indication of formatting using a plurality of tags in accordance with the mail markup language. At least one of the tags comprises a session tag delimiting a portion of the content and imposing processing limitations on a recipient of the electronic mail message such that the recipient must process content delimited by the session tag independently of other content of the electronic mail message.

In another exemplary embodiment, an apparatus for specifying a format of an electronic mail message using a mail markup language is provided. The apparatus of this embodiment includes a processor configured to receive content for inclusion in the electronic mail message. The processor of this embodiment is further configured to receive an indication of formatting for at least a portion of the content. The processor of this embodiment is additionally configured to add the received content to the electronic mail message. The processor of this embodiment is also configured to specify the format of the electronic mail message based at least in part upon the received indication of formatting using a plurality of tags in accordance with the mail markup language. At least one of the tags comprises a session tag delimiting a portion of the content and imposing processing limitations on a recipient of the electronic mail message such that the recipient must process content delimited by the session tag independently of other content of the electronic mail message.

In another exemplary embodiment, a method for processing an electronic mail message having a format specified in accordance with a mail markup language is provided. The method of this embodiment includes receiving an electronic mail message having a format specified with a plurality of tags in accordance with the mail markup language. At least one of the tags comprises a session tag delimiting a portion of the content and imposing processing limitations such that content delimited by the session tag must be processed independently of other content of the electronic mail message. The method of this embodiment also includes parsing the received electronic mail message to determine the format specified by the plurality of tags. The method of this embodiment additionally includes processing the content delimited by the session tag independently of other content of the electronic mail message in accordance with the processing limitations imposed by the session tag.

In another exemplary embodiment, an apparatus for processing an electronic mail message having a format specified in accordance with a mail markup language is provided. The apparatus of this embodiment includes a processor configured to cause an electronic mail message having a format specified with a plurality of tags in accordance with the mail markup language to be received. At least one of the tags comprises a session tag delimiting a portion of the content and imposing processing limitations such that content delimited by the session tag must be processed independently of other content of the electronic mail message. The processor of this embodiment is also configured to parse the received electronic mail message to determine the format specified by the plurality of tags. The processor of this embodiment is additionally configured to process the content delimited by the session tag independently of other content of the electronic mail message in accordance with the processing limitations imposed by the session tag.

In another exemplary embodiment, a method for disseminating a public key in an electronic mail message formatted in accordance with a mail markup language is provided. The method of this embodiment includes receiving an electronic mail address associated with an entity and an indication of a public key associated with the entity. The method of this embodiment further includes generating an electronic mail message comprising the received electronic mail address and indication of the public key by specifying a format of the electronic mail message using a plurality of tags in accordance with the mail markup language. At least one of the tags in this embodiment comprises a public key tag or a public key attribute delimiting the indication of the public key and binding the indication of the public key to the electronic mail address. The method of this embodiment also includes sending the electronic mail message to at least one recipient.

In another exemplary embodiment, an apparatus for disseminating a public key in an electronic mail message formatted in accordance with a mail markup language is provided. The apparatus of this embodiment includes a processor configured to receive an electronic mail address associated with an entity and an indication of a public key associated with the entity. The processor of this embodiment is further configured to generate an electronic mail message comprising the received electronic mail address and indication of the public key by specifying a format of the electronic mail message using a plurality of tags in accordance with the mail markup language. At least one of the tags in this embodiment comprises a public key tag or a public key attribute delimiting the indication of the public key and binding the indication of the public key to the electronic mail address. The processor of this embodiment is also configured to cause the electronic mail message to be sent to at least one recipient.

In another exemplary embodiment, a method for receiving an indication of a public key in an electronic mail message formatted in accordance with a mail markup language is provided. The method of this embodiment includes receiving an electronic mail message having a format specified with a plurality of tags in accordance with the mail markup language. At least one of the tags comprises a public key tag or a public key attribute delimiting an indication of the public key and binding the public key to an electronic mail address. The method of this embodiment also includes extracting the indication of the public key from the electronic mail message based at least in part upon the public key tag or the public key attribute.

In another exemplary embodiment, an apparatus for receiving an indication of a public key in an electronic mail message formatted in accordance with a mail markup language is provided. The apparatus of this embodiment comprises a processor configured to cause an electronic mail message having a format specified with a plurality of tags in accordance with the mail markup language to be received. At least one of the tags comprises a public key tag or a public key attribute delimiting an indication of the public key and binding the public key to an electronic mail address. The processor of this embodiment is further configured to extract the indication of the public key from the electronic mail message based at least in part upon the public key tag or the public key attribute.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for specifying content of electronic mail messages according to an exemplary embodiment of the present invention;

FIG. 2 illustrates a system for specifying content of electronic mail messages according to another exemplary embodiment of the present invention;

FIG. 3 illustrates a flowchart according to an exemplary method for specifying a format of an electronic mail message using a mail markup language according to an exemplary embodiment of the invention;

FIG. 4 illustrates a flowchart according to an exemplary method for processing an electronic mail message having a format specified in accordance with a mail markup language according to an exemplary embodiment of the invention;

FIG. 5 illustrates a flowchart according to an exemplary method for disseminating a public key in an electronic mail message formatted in accordance with a mail markup language according to an exemplary embodiment of the invention; and

FIG. 6 illustrates a flowchart according to an exemplary method for receiving an indication of a public key in an electronic mail message formatted in accordance with a mail markup language according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

### Mail Markup Language

By way of example, an exemplary specification for a mail markup language (MML) according to an exemplary embodiment of the invention is described below. As used herein, “exemplary” merely means an example and as such represents one example embodiment for the invention and should not be construed to narrow the scope or spirit of the invention in any way. It will be appreciated that the names of the tags are used for purposes of example and not construed to be limiting. Further, embodiments of MML according to the invention may specify different hierarchy requirements for use of tags and/or attributes in an MML document than that described below. However, the functionality provided by one or more tags and/or attributes in other embodiments of MML may be substantially similar to functionality provided by one or more tags and/or attributes defined in the exemplary specification below. Further, where a construct for an attribute of a tag is specified, it will be understood that the attribute may be specified in alternative embodiments as a child tag of the tag rather than an attribute of the tag.

MML is a tag based markup language used to describe and structure data in a document intended to represent communication across the medium of email. MML may be written in World Wide Web Consortium (W3C) extensible markup language (XML) Schema language. In this regard, all MML documents specified in accordance with this exemplary specification for MML are XML documents that conform to the MML schema. This exemplary specification is intended to replace RFC 5322.

MML as a standard provides both a language and a standard list of processing constraints upon that language.

The key words “MUST”, “MUST NOT”, “REQUIRED”, “SHALL”, “SHALL NOT”, “SHOULD”, “SHOULD NOT”, “RECOMMENDED”, “MAY”, and “OPTIONAL” as used in the exemplary specification for a mail markup language are to be interpreted as described in RFC 2119.

If an implementation, feature, or constraint does not satisfy a requirement level of MUST, or REQUIRED for its respective statement, clause, phrase, or section that implementation, feature, or constraint MUST be considered failed. Under such a circumstance, known as conditional compliance, a MML document MUST NOT be transmitted. The ideal MML document in accordance with this exemplary specification will satisfy all MUST, REQUIRED, and SHOULD conditions, known as unconditional compliance.

Terminology for Exemplary MML Specification

Tag: A tag is a code command enclosed in angle brackets such as, “<strong>”. Every tag exists as pairs of an opening tag and a closing tag. Closing tags are generally identical to their opening counter-part except that are preceded by a forward slash character, such as “</strong>”.

Element: The word “element” is synonymous and used interchangeably with the term “tag”.

Simple Block: A simple block is a tag that is capable of containing text and/or line-level tags.

Complex Block: A complex block is a tag that is capable of containing simple blocks or complex blocks.

Line-Level Tag: Line-level tags are only capable of existing in simple blocks. Line-level tags cannot contain other tags.

Processor: The term processor is to refer to any application, hardware, computer program product, or combination thereof that processes, interprets, or seeks to process a MML document. In this regard, processor may refer to the MML processor 128 described herein below. The term processor may refer to a device configured to execute a email client applications, but is not limited to such. The term “MML processor” used in this exemplary specification for a mail markup language may be synonymous to a device configured to function as a “mail client” as used by other related specifications and may likewise refer to the MML processor 128.

Accessibility: Accessibility is the degree of ease from which any human is equally capable of receiving data intended for human consumption from the desired document or request. Accessibility may refer to persons with a sensory disability, a motor disability, or software impairment.

Understandability: Understandability is the degree of ability by which a technology can be learned and used by a person who has never seen or used the technology previously. Understandability also refers to the lack of effort necessary for an experienced user to consume and process the technology.

Semantics: Semantics refers to the degree of description provided by meta-data and syntax rules either statically or through nesting and hierarchal implementation thereof. The objective of semantics is to provide the most expansive description of data intended for human consumption without that description interfering with understandability during reading or writing.

Structure: Structure refers to the effectual organization of data only as a result of well organized meta-data containers into a rigid hierarchy.

Session: In the context of MML the term session only refers to an instance of communication, which is defined by the <session></session> tags.

URI: The abbreviation “URI” stands for Uniform Resource Identifier. A URI is the address of a resource on a network or networks as defined by RFC 3986, addressed by RFC 3305, and supplemented by RFC 2368.

Processor Roles According to the Exemplary MML Specification

The role of a processor of MML in one embodiment is to conform to the following specified requirements. Processors of MML are, however, allowed certain freedoms from presumption that are also specified.

Processor Requirements and Constraints: The intent of imposing requirements and constraints unto the processor is to provide a uniform existence for data, meta-data, and syntax rules contained in a MML document not at the burden of a document author. In this regard, the imposed requirements and constraints may ensure the integrity of the MML language.

Validation: A MML document is preferably validated against the MML schema prior to transmission. If a MML document does not validate it MUST generally NOT be transmitted as email across any email specific protocol or Hyper Text Transfer Protocol. A MML processor is not REQUIRED to process any malformed or invalid MML document.

It is not invalid, according to some schema validators, for a session author to include empty tags, also known as nil content, such as <style></style>. It is, however, according to this exemplary specification, invalid to include nil content elements, in accordance with the XML Schema standard, without explicitly stating the XSI:nil=“true” attribute. Generally, empty tags MUST be removed by the MML processor during validation. Every tag SHOULD contain text, other tags, or both if so allowed.

RFC 2822/5322 Conformance: A MML processor of one embodiment creates RFC 5322 conformant mail headers for backwards compatibility. In this embodiment, MML aware clients/servers remove this header data and instead rely only upon the header information specified within the MML code. This ensures seamless transactions across the SMTP protocol to clients not prepared to receive MML. This header data is created after document validation for transport and prior to the document being transported.

Session Separation and Presentation: MML processors of one embodiment process each session of a MML document separately. This means a stylesheet specified in one particular session is not processed in another session on the same document. For instance a background specified, via stylesheet, in one session cannot exist as a background in any other session unless so specified in each other session even if in the same document.

A MML processor SHOULD generally allow session authors to alter the presentation of all elements and content in a session even if those elements or content exist outside the message body. This is not a requirement because MML processors MAY choose to display the session header information only in their application shell opposed to text.

Session Preservation All prior sessions received in a MML document are generally preserved verbatim, including whitespace and presentation. Decisions upon prior sessions MUST NOT be allowed except whether external assets MAY be processed. A MML processor SHOULD generally take steps to prevent prior sessions from manual alteration by a session author.

Character Set: The character set for this exemplary MML specification MUST is UCS-2 Big Endian, but other character sets may be employed in other embodiments.

Session Time-stamp: The value of the time-stamp attribute is typically written by the MML processor between the moment the session author submits the document for transmission and the validation by the MML processor. The MML processor may write over any value supplied by the author with the correct value. The value is generally based upon the local system clock.

URI Resolution: MML processors generally set a standard timeout for any URI that is referenced in a MML document. The length of that timeout MAY be determined by the MML processor. A MML processor MAY or MAY not allow its user to adjust the timeout length. If a MML processor cannot resolve any resource at its specified URI timeout that resource generally fails. If a URI is resolved but points to a location that is not the requested resource that resource also generally fails.

MIME Execution Restriction: Every object, stylesheet, or other external resource is generally processed strictly according to its specified MIME type. If a resource does not match its associated MIME type it is not executed. A MML processor is not REQUIRED to process any external resource.

Caching: External assets, such as stylesheets or objects, are generally cacheable by the MML processor. Caching significantly improves performs by reducing the demand for bandwidth and allowing access to content even when offline. Options, configuration, and implementation typically exist entirely at the discretion of the MML processor.

Local Processing: MML processors typically locally contain all required code components necessary to process and validate a MML document according to the MML schema. These components can be obtained from the following list:
mail.xsd
http://www.w3.org/MarkUp/Forms/2002/XForms-Schema.xsd
http://www.w3.org/MarkUp/SCHEMA/xml-events-attribs-1.xsd
http://www.w3.org/2001/XMLSchema.xsd
http://www.w3.org/2001/03/xml.xsd
http://www.w3.org/2001/XMLSchema.dtd
http://www.w3.org/2001/datatypes.dtd
mime.xsd

MML processors generally do not require the use of a network or internet connection to process or validate a MML document.

MIME Catalogue: A MML processor's list of MIME types generally exists as a local schema file. This file is available for editing by either an administrator or common user. Adding new MIME types to the list will likely result in a failure to process outside an internal network. Removing MIME types from the list generally results in a failure to process media of those types. By default the values in the MIME catalogue file will be every IANA registered type.

From and Reply-to Tags: The <from> and <reply-to> tags are required tags, so the tags will exist even if their content is null. If their content is null the MML processor of this embodiment supplies default values of the session author's email address. This MML processor supplied default content is generally supplied by the MML processor between the moment the session author submits the document for transmission and the validation by the MML processor. The default value for the <from> tag is generally the address represented by the author. The default value for the <reply-to> tag should match the default value of the <from> tag.

Session authors are allowed to specify content for these elements to hide their email address. The benefit is to customize how other session authors can control direct traffic, such as reply and forward traffic, back to their email address. These fields offer an actual traffic benefit, but no security advantage. MML processors generally do not use, process, or regulate the <from> or <reply-to> tags for any intent related to security. Email transmission protocols operate in unencrypted plain-text by default, which is where any user can easily find any address or identity information.

Attachments: In this embodiment, attachments are sent with the actual MML document. Attachment persistence is OPTIONAL. Persistence is a design choice of MML processor vendors. Attachment persistence refers to whether or not attachments will continue to be sent with the MML document after the document session arrives at its originally intended destination(s). A MML processor may allow users to choose to allow persistence.

Attachments are processed only according to their specified type. A MML processor is not REQUIRED to process any attachment. The type specified for <collection-type> generally represents every file in that respective <collection>. If the <collection-type> tag is not present the files located in the collection are generally not executable from the MML processor, MML document, or any other mail service software.

Processing of <plain-text>: Content provided in <plain-text> is generally processed as plain text characters and/or whitespace only. Code is not processed, rendered, or transformed in this tag.

Processing of style Attribute: The value supplied by the style attribute is defined in the MML schema as lowercase alpha characters, uppercase alpha characters, and/or numbers plus a colon character (:) plus lowercase alpha characters, uppercase alpha characters, and/or numbers. The characters supplied prior to the colon represent the value supplied in a <stylesheet-namespace> element of the same session. The value supplied after the colon generally represents a reusable processing declaration defined inside the stylesheet, such as a CSS class. An example of a supplied value: “namespaceName:CSSclass09”.

MML processors are not REQUIRED to process stylesheets. If the noted stylesheet cannot be resolved or if the value supplied by the style attribute is either malformed or fails to match a stylesheet of the same session this attribute is generally not processed.

Internationalization Attribute Processing: Text is typically processed in accordance with the defined values for the four internationalization attributes. Failure to process internationalization attributes according to their definition generally results in conditional compliance failure.

Refer Attribute Processing: The refer attribute is generally not allowed to reference id values outside the specific <markup> element containing the refer attribute.

Processor Allowances

This exemplary specification does not exist to define the role of MML processors for features that exceed the scope of this document. This exemplary specification only serves to dispel assumptions and specify certain freedoms allowed to MML processors that may not be allowed to processors of other markup languages.

Default Presentation This exemplary specification does not make any statements regarding presentation of the language. This means a MML processor is free to determine the default presentation for tags and objects. This default presentation MAY apply to any or all parts of a MML document. This means that presentation provided from a MML processor fits a wider scope than presentation specified by a MML author since any MML author can only specify presentation by use of an external stylesheet and stylesheet processing is limited to its session of the document.

MML processor default presentation is typically a lower priority than presentation defined in a stylesheet. If a conflict in presentation arises between the default and a stylesheet the presentation specified by the stylesheet generally dominates even in regards to cascading.

This means a MML processor typically determines font size, color, font, and so on until so specified by a stylesheet. A MML processor may also determine, by default, whether complex and simple blocks impose a line break, wrap, float, or so on.

A MML processor MAY or MAY not allow a user to customize or alter its default presentation. This specification will not mandate customization, however, accessibility concerns SHOULD be considered for changing text size, turning off stylesheets, and replacing objects with their respective text content.

Default Behaviors This exemplary specification states no directive for behaviors or controls upon the data or the usability thereof. There is no convention for allowing scripting in MML and any scripting that does exist is generally processed as plain text content. MML processors typically allow behaviors that increase accessibility more importantly than usability.

While Resource Document Framework (RDF) is not an included technology in this exemplary specification and should NOT interfere with conventions, syntax, data, or meta-data supplied in the document directly, semantic technologies MAY be used to auto-fill many areas of MML based upon a user's data habits. Semantic technologies MAY also be used for searching, data sorting, or other processing features to the data defined by the MML document. Those semantic technologies should NOT, however, alter the contents of the MML document.

Processing Elaborations Over Native MML Definitions: MML processors are capable of processing the full MML specification. MML processors MAY allow processing of or definition of elements or conventions not defined by this exemplary MML specification. Such elaborations should NOT interfere, limit, constrain, remove, or disable any aspect of the MML specification. Any elaboration, element, or convention not defined by this exemplary MML specification is not required of MML processors.

MML Schema Documentation For Exemplary MML Specification

The MML schema documentation is intended to provide a description of the mail markup language of this exemplary specification for a mail markup language along with justifications for certain conventions used.

In this example, if an element is followed by “0” it MAY occur 0 or 1 time. If an element is followed by “+” it MUST occur once, but it MAY occur more than once. If an item is followed by “0+” it MAY occur 0 or more times. If an element does not have these descriptors it MUST occur once and only once. Attributes MAY be followed by “0”, which indicates the attribute in concern is optional. Attributes MUST NOT occur more than once in any element. It is noted, however, that the following discussion is provided as one example and elements, tags, items, and attributes may be differently defined in other embodiments.

Those elements noted as (XForms) are defined by the XForms specification and not this exemplary MML specification These elements are generally processed in strict accordance with the XForms schema.

MIME Type Usage and mime.xsd: MIME types are stored in the mime.xsd document, which is merely a catalogue of all IANA registered MIME types. The information stored in mime.xsd is used in the MML schema through the use of the “mime-type” schema complex type.

Elements based upon the “mime-type” element type are generally allowed only one of nine possible child elements. These child elements each represent a IANA registered content type. The values for those child elements are a MIME sub-type that exists in the local mime.xsd file. The child elements are:
<application> or <audio> or <example> or <image> or <message> or <model> or <multipart> or <text> or <video>

MML Header Documentation

The code described in this section exists in MML documents without regard to how the message is formatted.

Root Element The root element of MML is the tag <mail>. The tag serves three purposes. First, the tag establishes the document as a MML document conforming to the mail.xsd schema. Second, the tag serves as a container of <session> tags. Third, the tag establishes important namespace information. The root element typically serves no further purpose.

<session> Tag: The session tag contains all information to represent an instance of communication including markup and header information. In one embodiment, session tag's child tags are as follows:
<address>
<attachment>0
<subject>
<presentation>0
<source> or <markup> or <plain-text>

The <session> tag's attributes:
time-stamp
language (optional)

The session tag of this embodiment allows three methods of communicating the message body. The source method allows a session author to send an external resource as the message body. The plain-text method allows a session author to communicate using only text characters and whitespace. The markup method allows a section author to use MML markup to describe the data.

The time-stamp attribute is described above with respect to the Session Time-stamp. The optional language attribute allows a session author to describe the majority language of the document. The default value in this exemplary specification is “EN”.

<address> tag: The address tag is a high level tag designed to store child tags containing email address information. In one embodiment, the child tags are:
<to>+
<copy>0+
<blind-copy>0+
<reply-to>
<from>

<to>, <copy>, <blind-Copy>, and <from> Tags: The <to>, <copy>, <blind-copy>, and <from> may be identical in their syntax. They may only differ in their use by the MML processor. These tags store the value of a properly formed email address. These tags may contain the optional attributes of alias and public-key. The alias is designed to contain a value that is a more human readable representation of an email address, such as a person's name. The public-key attribute is intended to store text characters that represent a hashed public-key for asymmetric encryption.

In one embodiment, the <to>, <copy>, <blind-Copy>, and <from> tag's attributes comprise:
alias (optional)
public-key (optional)

<reply-to> Tag: The <reply-to> tag may be identical to the <from> tag except that it may contain either a valid email address or a value of no-reply. This tag is generally used to set an address for deflecting email replys from the address used to send the email or to establish an alternate destination for receiving replies.

<attachments> Tag: The <attachments> tag is a high level tag for specifying file(s) to be attached to the document. Attached files are not intended for processing in the message body. In one embodiment, this tag has two children which may occur as many times as needed. At a minimum only one of these child elements generally MUST occur:
<collection>+ and/or <file>+

<collection> Tag: The <collection> tag is intended to serve as a collection of multiple files of the same specified type. In one embodiment, this tag has four child tags:
<collection-name>
<collection-file>+
<collection-type>0
<collection-description>

<collection-name> Tag: In one embodiment, <collection-name> tag is a REQUIRED child of <collection>. This may be any string value on a single line. The intent of this tag is to provide a simple name or label for the attached collection.

<collection-file> Tag: <collection-file> tag stores the file name of a particular file in a collection. in one embodiment, this tag MUST exist for each file that is to exist in the collection.

<collection-type> Tag: The <collection-type> tag is a “mime-type” complex-type tag as specified in mime.xsd. The value provided for this tag generally represents every file in the collection. This tag is optional. If this tag is not present the files present in the collection are generally not processed by the MML processor. MML processors are not REQUIRED to process attached collections.

<collection-description> Tag: This tag exists to specify a description of the collection. Examples of content for this tag MAY be examples of intended use, explanations, file ownership, origin information, and so forth.

<file> Tag: The <file> tag is intended to serve as a single attached file. In one embodiment, this tag has three child tags:
<file-name>
<file-type>
<file-description>

<file-name> Tag: <file-name> tag is a child of <file>. The value for this tag is generally a non-colonized name. This tag represents the name of the file being attached.

<file-type> Tag: This tag is of type “mime-type”. In one embodiment, the attached file is processed according to the value supplied in this tag, or it MUST NOT be processed by a MML processor. MML processors are not required to process attached files.

<file-description> Tag: This tag allows a session author to enter any normalized string value that describes the attached file.

<subject> Tag: The <subject> tag value must be a normalized string. This required tag sets the subject of the document session. This tag is equivalent to the subject of traditional email.

<presentation> Tag: All presentation, aside from MML default presentation, is set for a session in this high level tag. This tag is a container for its one child element that may occur more than once.
<stylesheet>+

<stylesheet> Tag: Each <stylesheet> tag represents a single stylesheet reference. This tag has a valid URI as its value and has two required attributes and one optional attribute. The optional media attribute identifies the output media the stylesheet is attempting to supply presentation for. If this attribute is not specified its default value of “screen” is generally assumed. The required attribute style-namespace is a named value that will serve as named prefix for stylesheet declarations from this stylesheet. The prefix is generally REQUIRED for stylesheet references using the “style” attribute that is available to elements in the <markup> section of the session. In one embodiment, the attribute, “style-type”, accepts only one of three values:
application/xml
text/xsl
text/css
<source> Tag: The <source> tag is one of three methods of creating the message body. The intent of this tag is to allow an external resource to act as the message body. There is no requirement for a MML processor to process any external resource, so the content established by the <source> tag may not always be communicated. This tag generally has two REQUIRED children:
<source-uri>
<source-type>

<source-uri> Tag: This tag contains a URI of the requested resource that is to act as the body of the session.

<source-type> Tag: This tag is of element type “mime-type”. The type determines how or if the external resource described in <source-uri> will be processed by the document's destination.

<plain-text> Tag: This tag is the second of the three methods for communicating the body of the session. This tag contains only plain text. Code MUST generally NOT be processed in this tag. The intent of this tag is to allow session authors to communicate using text without interference to the processing of that content. Presentation MAY be applied to <plain-text> content if the MML processor so allows and a stylesheet is provided.

<markup> Tag: This tag allows the use of MML to describe and organize content.

<markup> Organization of Types and Groups

This section is intended to providing descriptive documentation for the part of the language dedicated to describing information that is intended to be read by an email recipient as a message body, in accordance with one embodiment.

<markup> Element Organization: The elements in this section of MML are arranged in three groups: complex-blocks, simple-blocks, and inline elements.

A complex-block is a tag that is capable of containing either simple-blocks or simple-blocks plus other complex-blocks. Complex blocks are not capable of containing text content of inline elements. These following tags are examples of the high level complex-blocks:
<define-list>
<navigation-list>
<order-list>
<unorder-list>
<table>
<section>
<form>

A simple-block is a tag that is capable of containing text and inline elements, but is not capable of containing other simple-blocks or complex-blocks, such as:
<block-code>
<block-quote>
<citation>
<heading>
<object>
<paragraph>
<separator>

Inline elements are not structural elements. These elements exist in a simple-block container. Inline elements are intended to describe text content, supply additional meta-data, or apply more specific presentation as follows:
form controls (XForms)
<short>
<button>
<cite>
<emphasis>
<identifier>
<quote>
<format>
<strong>
<title>

<markup> Attribute Organization

The attributes in the <markup> section of MML are arranged in the following attribute groups: “core attributes”, “core attributes plus uri”, “internationalization attributes”, and “cell attributes”.

The “core attributes” are applied to nearly every element in the markup section. This attribute group is always optional. The group may contain the following attributes:
id
title
style
role

The “core attributes plus uri” group is literally the “core attributes” group with the added uri attribute. It was desirable to specify these two groups separately because many elements require a URI and many MUST NOT receive a URI. In one embodiment, these attributes are in the “core attributes plus uri” group:
id
title
style
role
uri

The “internationalization attributes” exist to alter the order in which text is rendered. This is not a presentation issue of altering how text appears, but how it appears to work to the computer for the benefit of assistive technologies and other languages. This group may contain these attributes:
direction
orientation
wrap
section-language

The “cell attributes” group is a set of attributes specific to table cell elements. These attributes may include the following:
span-column
span-row

<markup> Attributes

<markup attributes> of this exemplary specification for a MML comprise attributes used by various tags in the <markup> section of a MML document.

id Attribute: This attribute exists to assign a unique identification to an element. The value for this attribute generally contains only lowercase alpha characters, uppercase alpha characters, and/or numbers. The value generally does NOT contain any other characters including whitespace. This attribute is intended to create a unique hook to a particular element for MML processor specific behavior or presentation. There are some elements that exist as a pair set and require the id attribute to refer to each other. The id attribute is unique per <session> section and MAY NOT be unique per a MML document of multiple sessions.

title Attribute: The title attribute is intended to supply additional content to an element beyond its contained text. The value for this attribute is whitespace normalized text. This attribute is supplied for the semantic and accessibility benefits of expanded meta-data for human consumption.

style Attribute: This attribute exists to reference a reusable stylesheet property. The value for this attribute is generally a set of lowercase alpha characters, uppercase alpha characters, and/or numbers plus a colon (:) plus lowercase alpha characters, uppercase alpha characters, and/or numbers. The value before the colon represents the value of any supplied <stylesheet-namespace> element. This tells the MML processor which stylesheet the style reference is referring to. The value after the colon represents some value defined in the stylesheet, such as a CSS class name. An example is: “names pace: CSScl ass09”.

role Attribute: This attribute is intended to allow for specific semantic redefinition of any element where its use is allowed. If a session author had the ability to rename a tag to something more semantically specific that new name is the value that SHOULD fill the role attribute. The value of the role attribute SHOULD NOT challenge or contradict the intent of the named element it is used with.

The WAI-ARIA technology and RDF derived technologies are expected to benefit from use of the role attribute.

uri Attribute: This attribute generally contains only a URI value as defined by RFC 3986 or RFC 2368 for email addresses specifically. Use of this attribute is equivalent to a webpage hyperlink. A same-document reference generally refers only to the value of a specified id attribute value within the same session.

direction Attribute: The direction Attribute determines which direction the text is to flow as it is typed. The default value is left to right if orientation has a value of horizontal or top to bottom if orientation has a value of vertical. The acceptable values are “tl”, which indicates starting from the top or left, or “br”, which indicates starting from the bottom or right.

orientation Attribute: This attribute determines whether text characters render in a vertical or horizontal manner. The acceptable values are “horizontal” or “vertical”. Horizontal is the default value.

wrap Attribute: This attribute determines how lines of text are rendered to the page. The acceptable values for this attribute are “standard”, “reverse”, or “none”. A value of “standard” does nothing different and is the default value. The value “reverse” forces text render opposite of its standard behavior.

Assuming direction and orientation are at default, standard behavior according to one embodiment is to wrap a line of text below the prior existing text. Under those conditions a value of “reverse” forces the line of text to wrap above the prior existing line of text.

A value of “none” forces the text to not wrap. Under the condition that non-wrapping text is wider or taller than its container the container stretches and the page scrolls to keep the text visibly legible so long as there are not presentation specifications to the contrary.

section-language Attribute: The attribute section-language specifies the language of a particular section, container, or element in the <markup> section. This alerts readers and semantic devices that the language has changed from the default specified language. The values for this attribute are generally a two digit XML language code.

span-column Attribute: This attribute allows a <table-cell> or <head-cell> to occupy more than one column in a table. The values for this attribute are generally positive integers. The default value may be “1”.

span-row Attribute: The attribute span-row allows a <table-cell> or <head-cell> to occupy more than one row in a table. The values for this attribute are generally positive integers. The default value may be “1”.

refer Attribute: This attribute is a reference to the value of an id attribute supplied on another element of the same <markup> section. In one embodiment, if the value of this attribute does not match an existent id attribute value the document should not validate.

scope Attribute: This attribute is used in table header cells to determine which table cells the header is providing a heading for. In this embodiment, the values for this attribute are: column, row, group-column, or group-row.

The value “column” dictates that a header cell is providing a heading for only the first column of cells the header cell occupies. The value “row” dictates that a header cell is providing a heading for only the first row of cells the header cell occupies. A value of “group-column” dictates that a header cell provides a heading for all cells in all columns that it occupies. The value “group-row” dictates the header cell is providing a heading for all cells in all rows it occupies.

long-form Attribute: This attribute serves to represent the expanded text that is described by the <short> element. An example is: <short long-form=“Mail Markup Language”> MML</short>.

<markup> Elements

<markup> Elements listed in this section of this exemplary section comprise a per element list of all elements that MAY exist in the <markup> section of a MML document.

<define-list> Tag: This element is intended to establish a list of definitions by matching any number of defining terms to any number of definitions. In one embodiment, this element contains only one child element, but that element may be used more than once.

Child:
<define-item>+

Attributes:
core attributes 0

<define-item> Tag: The <define-item> tag represents a single defining instance.

The associations drawn by the child tags may be as follows: multiple defining terms mapped to a single definition, a single term mapped against multiple definitions, or multiple terms that commonly share multiple definitions. As a result of these three possible associations at least one of each child element must occur. Children:
<define-term>+
<definition>+

Attributes:
core attributes 0

<define-term> Tag: This tag is intended to contain a single term, phrase, or clause to be defined. The value for this tag must be whitespace collapsed text.

Attributes:
core attributes plus uri 0
internationalization attributes 0

<definition> Tag: This tag is intended to contain the definition text that defines the associated terms. The value for this tag can be text and inline elements.

Children:
inline elements 0+

Attributes:
core attributes 0
internationalization attributes 0

<navigation-list> Tag: The <navigation-list> tag establishes a list of items that exist to either direct traffic or create a menu of URIs. This tag allows for either a heading or a set of descriptive text and at least one navigation item.

Children:
<heading>0 or <identifier>0
<navigation-item>+

Attributes:
core attributes 0

<navigation-item> Tag: This element is a single instance of navigation in a list of navigation choices. This element may contain either an object for navigation or text for navigation as determined by its child tags. A uri attribute is generally included with this element.

Children:
<navigation-object> or <navigation-text>

Attributes:
core attributes 0
uri

<navigation-object> Tag: The <navigation-object> is a standard <object> that is modified to not allow use of the uri attribute. In one embodiment, this tag is only used if the focus of navigation for the <navigation-item> of concern is an external resource expected to be processed into the content of the message body. Two children elements are generally REQUIRED.

It is important that an object contain text content that describes its resource. There is no requirement for MML processors to process any external resource. If the resource does fail to process the text contained by the object is generally displayed.

Children
<object-text>
<object-uri>
<object-type>

Attributes:
core attributes 0
internationalization attributes 0

<navigation-text> Tag: The content of this element is text and whitespace that is the focus of navigation. This tag has no child elements.

Attributes:
core attributes 0
internationalization attributes 0

<order-list> Tag: An ordered list is a list where each item in that list is enumerated in the meta-data so that the position of elements in the list relative to other list items is valid data. Whether or not this enumeration appears is to a human reader is strictly a presentation concern. This element is allowed descriptive text in the form of a <heading> or <identifier> child. Each occurs in the list exists in the <list-item> child. An example of a list that must be ordered is step-by-step directions, such as a recipe.

Children:
<heading>0 or <identifier>0
<list-item>+

Attributes:
core attributes 0

<unorder-list> Tag: An unordered list is nearly identical to an ordered list except that list items are not enumerated. This means position of items in the list is irrelevant.

Children:
<heading>0 or <identifier>0
<list-item>+

Attributes:
core attributes 0

<list-item> Tag: This element represents a single listed instantiation in a either an ordered or unordered list. This element may contain a single simple block element or text plus 0 or more inline elements.

Children:
simple block element or text plus inline elements 0+

Attributes:
core attributes 0
internationalization attributes 0

<form> Tag: The <form> tag is the high level parent container of a form. A form allows organized controls upon input and submission of information in a method different than a standard email reply.

Children:
<model> (XForms)
<form-body>

<form-body>: The <form-body> element is intended to contain all the form controls that a user could interact with plus other MML elements.

Children:
<define-list>0+
<navigation-list>0+
<order-list>0+
<unorder-list>0+
<table>0+
simple blocks 0+
form controls 0+ (XForms)

<table> Tag: The <table> element allows authors to store and organize data in a grid or chart fashion.

Children:
<head-row>0
<table-row>+

Attributes:
core attributes 0

<head-row> Tag: The header row is a container of header cells to provide meta-data for tables.

Child:
<head-cell>+

Attributes:
core attributes 0

<table-row> Tag: A <table-row> MAY carry header cells or standard table cells. A row is the standard unit of organization in a MML table.

Children:
<head-cell>+ or <table-cell>+

Attributes:
core attributes 0

<head-cell> Tag: A header cell provides meta-data that either labels or describes the data contained within its scope. The scope of the header cell is determined by use of the scope attribute. A header cell generally contains either a single simple block or text plus any number of inline elements.

Children:
simple blocks 0 or text plus inline elements 0+

Attributes:
cell attributes 0
core attributes 0
internationalization attributes 0
scope 0

<table-cell> Tag: The table cell is the standard unit of data in a table cell. A table cell is not intended to provide any meta-data about the table or the structure of the table. A table cell is intended to provide data directly to the user. A table cell generally contains either a single complex block or text plus any number of inline elements.

Children:
simple blocks 0 or text plus inline elements 0+

Attributes:
cell attributes 0
core attributes 0
internationalization attributes 0

<section> Tag: A section is a high level structural organization block. This is the only complex block capable of containing itself, such as nesting. The intent of the <section> tag is to subdivide the markup into various smaller areas for content organization, separation, and semantics.

Children:
complex blocks 0+ and/or simple blocks 0+

Attributes:
core attributes 0

<block-code> Tag: The block code simple block is intended to convey and describe code. The contents of this container generally do not directly contain XML reserved characters. An XML processor is not generally told to process characters that construct its syntax. These reserved characters can be used if they are escaped with a character entity reference. In one embodiment, the reserved characters and their corresponding character entity references are:

| Character | Hex Name |
|---|---|
| < | &#60; &lt; |
| > | &#62; &gt; |
| & | &#38; &amp; |
| “ | &#34; &quot; |
| ′ | &#39; &apos; |

Children:
text and inline elements 0+

Attributes:
core attributes 0
internationalization attributes 0

<block-quote> Tag: A block quote is a large quotation that MAY span several statements. This element can contain text and any number of inline elements.

Children:
text and inline elements 0+

Attributes:
core attributes 0
internationalization attributes 0

<citation> Tag: A citation is a descriptive reference to a piece of information used in content by a session author. The information referenced by the <citation> tag automatically points to the content that requires it by use of a required id attribute, which is referred to by the inline tag <cite>. This element contains text and any number of inline elements.

Children:
text and inline elements 0+

Attributes:
id
title 0
style 0
role 0
internationalization attributes 0

<heading> Tag: A heading is a short block of text that describes the content that is to follow. The <heading> tag contains text and MAY contain 0 or more inline elements.

Children:
text and inline elements 0+

Attributes:
core attributes 0
internationalization attributes 0

<object> Tag: An object is any external resource that is intended to be processed among the content of the message body, such as an image or video. Objects may have two required child tags and are intended to contain text content.

An object generally contains text content that describes its resource. There is no requirement for MML processors to process any external resource. If the resource does fail to process the text contained by the object is generally displayed.

Children:
<object-text>
<object-uri>
<object-type>
inline elements 0+

Attributes:
core attributes
internationalization attributes

<object-text> Tag: Object text is the alternative text content that is to be rendered as content if the object cannot be resolved or processed.

<object-uri> Tag: This element contains a URI value and that URI points to the location of a resource to appear in the message body. This element allows no child elements or attributes.

<object-type> Tag: This element is of type “mime-type”. The object pointed to by the sibling <object-uri> tag is processed according to the type specified by this tag.

<paragraph> Tag: This element is the standard generic container of text and inline elements in a MML document. This element represents a paragraph and text is most typically grouped in paragraphs.

Children:
text and inline elements 0+

Attributes:
core attributes 0
internationalization attributes 0

<separator> Tag: This element is intended for semantic and structural purposes only. Use of this element indicates a structural obstruction in the flow or organization of content within a single section. This element MAY contain text, which should indicate or explain the nature or reasoning of separation mandated by use of this element.

Children:
text and inline elements 0+

Attributes:
core attributes 0
internationalization attributes 0

<short> Tag: This inline element describes text that is a short-hand value, such as an abbreviation or acronym.

Attributes:
long-form
core attributes plus uri 0

<button> Tag: This element exists to encourage interaction from a user. The version of MML specified by this exemplary specification for a mail markup language does not allow for client-side scripting, limiting the potential of a button, although a button MAY be able to interact with media that performs its own internal scripting, such as Flash media.

Attributes:
refer 0
core attributes plus uri 0

<cite> Tag: The <cite> tag is intended to contain text begging a citation. The refer attribute points to the id attribute of a <citation> in the same <markup> section of the document.

Attributes:
refer
core attributes 0

<emphasis> Tag: This tag indicates the text it contains is more important than other text of the same context.

Attributes:
core attributes plus uri 0

<identifier> Tag: This element is intended to provide a text label that describes some other element. This element has an attribute of refer so that it may refer to the id of the element it is attempting to describe.

Attributes:
refer
core attributes plus uri 0

<quote> Tag: This element indicates the content it contains is a quotation.

Attributes:
core attributes plus uri 0

<format> Tag: The format tag is special in that in one embodiment, it provides no semantic data. This tag is available to provide access to the core attributes without imposing semantic considerations. A session author MAY need to apply style or a uri attribute to some text that is otherwise no different than the text around it. This is also the only inline tag that MAY contain a child tag.

Child:
<format> 0+

Attributes:
core attributes plus uri 0

<strong> Tag: This tag indicates the content it contains is begging attention regardless of the importance or relevance of the content in its given context.

Attributes:
core attributes plus uri 0

<title> Tag: This element indicates either a person's official title or the title of a work.

Attributes:
core attributes plus uri 0

It will be appreciated that the above exemplary specification for a mail markup language was provided merely for purposes of example of one embodiment of a mail markup language provided by the invention and is not intended to be limiting in any way. In this regard, the invention encompasses any markup language tailored for electronic mail providing at least some of the functionality as described herein. Accordingly, embodiments of the invention comprise mail markup languages having a selection, coordination, and/or arrangement of tags and attributes other than that described in the above exemplary specification for a mail markup language.

### Computing Devices and a System for Implementing a Mail Markup Language

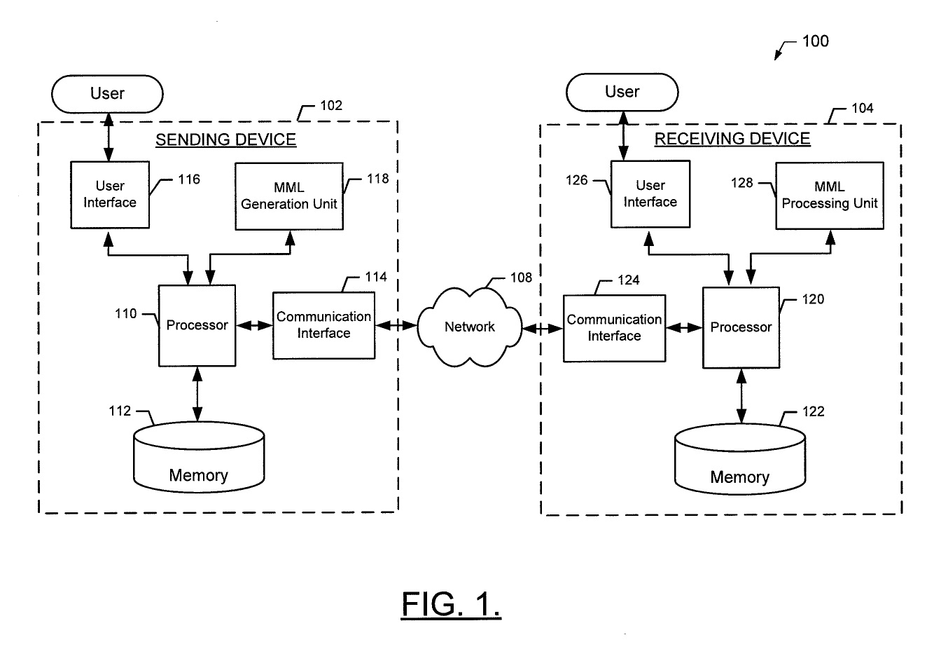

FIG. 1 illustrates a block diagram of a system 100 for specifying content of electronic mail messages using a mail markup language (MML) according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for specifying content of electronic mail messages using a mail markup language, numerous other configurations may also be used to implement embodiments of the present invention.

In at least some embodiments, the system 100 includes a sending device 102 and receiving device 104 configured to communicate over a network 108. The network 108 may comprise a wireline network, wireless network, or some combination thereof. In an exemplary embodiment, the network 108 comprises the internet.

The sending device 102 may comprise any computing device configured to generate an electronic mail message and send the electronic mail message to a receiving device 104 over the network 108. In this regard, the sending device 102 may, for example, be embodied as a server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like.

In an exemplary embodiment, the sending device 102 includes various means, such as a processor 110, memory 112, communication interface 114, user interface 116, and MML generation unit 118 for performing the various functions herein described. These means of the sending device 102 as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 110 comprises a plurality of processors. The plurality of processors may be embodied on a single computing device or distributed among a plurality of computing devices. The plurality of processors may be in operative communication with each other and may be collectively configured to perform one or more functionalities of the sending device 102 as described herein. In an exemplary embodiment, the processor 110 is configured to execute instructions stored in the memory 112 or otherwise accessible to the processor 110. These instructions, when executed by the processor 110, may cause the sending device 102 to perform one or more of the functionalities of the sending device 102 as described herein. As such, whether configured by hardware or software methods, or by a combination thereof, the processor 110 may comprise an entity capable of performing operations according to embodiments of the present invention when configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, the instructions may specifically configure the processor 110, which may otherwise be a general purpose processing element if not for the specific configuration provided by the instructions, to perform one or more algorithms and operations described herein

The memory 112 may include, for example, volatile and/or non-volatile memory. Although illustrated in FIG. 1 as a single memory, the memory 112 may comprise a plurality of memories. The memory 112 may comprise volatile memory, non-volatile memory, or some combination thereof. In this regard, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 112 may be configured to store information, data, applications, instructions, or the like for enabling the sending device 102 to carry out various functions in accordance with exemplary embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the MML generation unit 118 during the course of performing its functionalities.

The communication interface 114 may be embodied as any device or means embodied in hardware, a computer program product comprising computer readable program instructions stored on a computer readable medium (e.g., the memory 112) and executed by a processing device (e.g., the processor 110), or a combination thereof that is configured to receive and/or transmit data from/to a remote device over the network 108. In at least one embodiment, the communication interface 114 is at least partially embodied as or otherwise controlled by the processor 110. In this regard, the communication interface 114 may be in communication with the processor 110, such as via a bus. The communication interface 114 may include, for example, a network interface controller (NIC), an antenna, a transmitter, a receiver, a transceiver and/or supporting hardware or software for enabling communications with other entities of the system 100. The communication interface 114 may be configured to receive and/or transmit data using any protocol that may be used for communications between computing devices of the system 100. The communication interface 114 may additionally be in communication with the memory 112, user interface 116, and/or MML generation unit 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. The user interface 116 may provide an interface allowing a user to enter and/or select content to be added to an electronic mail message as well as to input an indication of how the content should be formatted in the electronic mail message. The user interface 116 may be in communication with the memory 112, communication interface 114, and/or MML generation unit 118, such as via a bus.

The MML generation unit 118 may be embodied as various means, such as hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In an exemplary embodiment, the MML generation unit 118 is embodied as a computer program product and/or hardware comprising an email application configured to send and/or receive electronic mail messages. In embodiments where the MML generation unit 118 is embodied separately from the processor 110, the MML generation unit 118 may be in communication with the processor 110. The MML generation unit 118 may further be in communication with the memory 112, communication interface 114, and/or user interface 116, such as via a bus.

In at least some embodiments, the MML generation unit 118 is configured to receive content for inclusion in an electronic mail message. The content may be entered and/or specified by a user over the user interface 116. The MML generation unit 118 may be further configured to receive an indication of formatting for at least a portion of the content. Based at least in part upon the received content and/or received indication of formatting, the MML generation unit 118 may be configured to generate an electronic mail message comprising the received content and specify a format for the content using a hierarchy of a plurality of tags. The MML generation unit 118 may specify the plurality of tags in accordance with a mail markup language. In this regard, the MML generation unit 118 may be configured to specify a format for an electronic mail message using any embodiment of a mail markup language, such as, for example, the exemplary embodiments described above. The MML generation unit 118 may additionally or alternatively be configured to specify a format for an electronic mail message using other markup languages.

Referring now to the receiving device 104, the receiving device 104 may comprise any computing device configured to receive an electronic mail message sent by the sending device 102 over the network 108. In this regard, the receiving device 104 may, for example, be embodied as a server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like.

In an exemplary embodiment, the receiving device 104 includes various means, such as a processor 120, memory 122, communication interface 124, user interface 126, and MML processing unit 128 for performing the various functions herein described. These means of the receiving device 104 as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be embodied on a single computing device or distributed among a plurality of computing devices. The plurality of processors may be in operative communication with each other and may be collectively configured to perform one or more functionalities of the receiving device 104 as described herein. In an exemplary embodiment, the processor 120 is configured to execute instructions stored in the memory 122 or otherwise accessible to the processor 120. These instructions, when executed by the processor 120, may cause the receiving device 104 to perform one or more of the functionalities of the receiving device 104 as described herein. As such, whether configured by hardware or software methods, or by a combination thereof, the processor 120 may represent an entity capable of performing operations according to embodiments of the present invention when configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, the instructions may specifically configure the processor 120, which may otherwise be a general purpose processing element if not for the specific configuration provided by the instructions, to perform one or more algorithms and operations described herein

The memory 122 may include, for example, volatile and/or non-volatile memory. Although illustrated in FIG. 1 as a single memory, the memory 122 may comprise a plurality of memories, which may be embodied on a single computing device or distributed across a plurality of computing devices. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the receiving device 104 to carry out various functions in accordance with exemplary embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the MML processing unit 128 during the course of performing its functionalities.

The communication interface 124 may be embodied as any device or means embodied in hardware, a computer program product comprising computer readable program instructions stored on a computer readable medium (e.g., the memory 122) and executed by a processing device (e.g., the processor 120), or a combination thereof that is configured to receive and/or transmit data from/to a remote device over the network 108. In at least one embodiment, the communication interface 124 is at least partially embodied as or otherwise controlled by the processor 120. In this regard, the communication interface 124 may be in communication with the processor 120, such as via a bus. The communication interface 124 may include, for example, a network interface controller (NIC), an antenna, a transmitter, a receiver, a transceiver and/or supporting hardware or software for enabling communications with other entities of the system 100. The communication interface 124 may be configured to receive and/or transmit data using any protocol that may be used for communications between computing devices of the system 100. The communication interface 124 may additionally be in communication with the memory 122, user interface 126, and/or MML processing unit 128, such as via a bus.

The user interface 126 may be in communication with the processor 120 to receive an indication of a user input and/or to provide an audible, visual, mechanical, or other output to the user. As such, the user interface 126 may include, for example, a keyboard, a mouse, a joystick, a display, a touch screen display, a microphone, a speaker, and/or other input/output mechanisms. The user interface 116 may provide an interface allowing a user to see and/or hear content included in a received electronic mail message. In this regard, the user interface 116 may comprise an output device. The output device may comprise, for example, a display device for displaying a visual rendering of an electronic mail message, a printer device for printing an electronic mail message, a speaker for audibilizing content of an electronic mail message, and/or the like. The user interface 126 may be in communication with the memory 122, communication interface 124, and/or MML processing unit 128, such as via a bus.

The MML processing unit 128 may be embodied as various means, such as hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In an exemplary embodiment, the MML processing unit 128 is embodied as a computer program product and/or hardware comprising an email application configured to send and/or receive electronic mail messages. In embodiments where the MML processing unit 128 is embodied separately from the processor 120, the MML processing unit 128 may be in communication with the processor 120. The MML processing unit 128 may further be in communication with the memory 122, communication interface 124, and/or user interface 126, such as via a bus.

In at least some embodiments, the MML processing unit 128 is configured to receive an electronic mail message sent by the sending device 102 over the network 108. the electronic mail message may have a format specified with a hierarchy of a plurality of tags in accordance with a mail markup language. The MML processing unit 128 may be further configured to parse the received electronic mail message to determine a format specified by the plurality of markup tags and then process the content of the electronic mail message based at least in part upon the format specified by the tags in accordance with the mail markup language. The MML processing unit 128 may be additionally configured to cause the processed content of the electronic mail message to be published to an output device of the user interface 126 in accordance with the format specified by the tags based at least in part upon the parsing and processing.

It will be appreciated that although the sending device 102 and receiving device 104 are described herein with different attributed functionality, the sending device 102 may be configured to perform at least some of the functionality attributed to the receiving device 104, such as may be attributed to the MML processing unit 128. Likewise, the receiving device 104 may be configured to perform at least some of the functionality attributed to the sending device 102, such as may be attributed to the MML generation unit 118. In this regard, the sending device 102 and receiving device 104 are defined so as to clearly illustrate operations that may be performed by a sender of an electronic mail message and a receiver of an electronic mail message. In practice, and according to embodiments of the invention, however a single computing device may function as both a sending device 102 and a receiving device 104 such that the single computing device is configured to both send electronic mail messages to and receive electronic mail messages from other computing devices. Accordingly, a single computing device may comprise both an MML generation unit 118 and an MML processing unit 128.

### Communication Instance Separation

In at least some embodiments of the invention, a mail markup language is provided that enables separation of communication instances through use of a session tag. An example construct of a session tag according to some embodiments of the invention has been described above in connection with the <session> tag described in the exemplary specification for a mail markup language. In this regard, an electronic mail message having a format specified with a plurality of tags in accordance with a mail markup language (e.g., a MML document) may comprise one or more session tags. Each session tag may delimit a portion of the content of the electronic mail message and impose processing limitations on a recipient of the electronic mail message, such as the receiving device 104, such that the recipient must process content delimited by the session tag independently of other content of the electronic mail message.

In this regard, the MML generation unit 118 may be configured to receive content for inclusion in an electronic mail message and a formatting indication indicating that at least a portion of the content is to be comprise a separate communication instance. The separate communication instance may, for example, comprise content of a reply to an email that the MML generation unit 118 may delimit with session tags to separate the reply content from one or more previous emails in the email chain (e.g., content of the email which is being replied to). In another example, the MML generation unit 118 may be configured to receive multiple sets of content from a single author and/or sets of content from multiple authors. The MML generation unit 118 may further receive a formatting indication indicating that the respective sets are to comprise separate communication instances and thus the MML generation unit 118 may specify a format for the electronic mail message wherein each set of content comprising a separate communication instance is delimited by a respective session tag. The session tags may impose a processing limitation on the receiving device 104 such that the MML processing unit 128 must process content delimited by each respective session tag independently of content delimited by other session tags and independently of other content of the electronic mail message.

Accordingly, a session tag may be described to “sandbox” content delimited by the session tag from other content of an electronic mail document. This sandboxing may be beneficial in allowing users to be fully expressive in formatting content within an individual communication instance. Accordingly, for example, the MML generation unit 118 may be configured to apply a stylesheet to content delimited by a session tag and due to processing limitations imposed by the session tag, the MML processing unit 128 may be configured to apply the stylesheet only to content delimited by the session tag. Thus, for example, formatting applied to one communication instance will not affect formatting applied to another communication instance, thus enabling more complex email layouts as a stylesheet may be specified for a communication instance without affecting a stylesheet or other formatting applied to another communication instance. In one example, this may enable insertion of a communication instance comprising an advertisement into an electronic mail message wherein the advertising content and formatting therefore comprises a communication instance delimited by a session tag without affecting a second communication instance including content and formatting specified by another author of the electronic mail message. In another example, if there are a chain of emails, a user replying to the chain may specify a format for the content of his reply and the MML generation unit 118 may be configured to delimit the reply content with a session tag and apply the user-specified format to the delimited reply content. The formatting of the reply is then sandboxed by the session tag such that it will not affect formatting applied to previous email(s) in the chain and thus each respective email in the chain that is delimited by session tags may be viewed as intended by the original author without any conflict from formatting applied to other emails.

### Attaching Collections of Files to Electronic Mail Messages

Some embodiments of the invention facilitate attachment of a collection of a plurality of files to an electronic mail message. In this regard, the MML generation unit 118 may be configured to receive content comprising a plurality of files for simultaneous attachment to an electronic mail message. The plurality of files may all comprise the same Multipurpose Internet Mail Extension (MIME) type such that the MML generation unit 118 only needs to define a MIME type once for the entire collection of a plurality of files. The MML generation unit 118 may be configured to include a collection tag in an electronic mail message to delimit the collection of a plurality of files. In at least some embodiments, the MML processing unit 128 is accordingly configured to parse the collection tag and extract the files contained by the tag when processing a received electronic mail message including a collection tag. An example construct of a collection tag according to some embodiments of the invention has been described above in connection with the <collection> tag described in the above exemplary specification for a mail markup language.

In this regard, the attachment of a collection of a plurality of files differs from the attachment of files to an email prior to the current invention. In previous attachment procedures, users have only been able to attach a single file at a time as a MIME type has been required to be defined for each file as it is attached to the email.

### Specifying Content of an Electronic Mail Message Using MML

In at least some embodiments of the invention, a mail markup language may facilitate multiple methods of specifying and processing content. In a first method, plain text, such as, for example in accordance with the Unicode character processing model, may be used to specify content of an electronic mail message. In this regard, the MML generation unit 118 may be configured to generate an electronic mail message with content specified as plain text and the MML processing unit 128 may be configured to process a received electronic mail message having content specified as plain text.

In a second method, content of an electronic mail message may be specified using mail markup using any combination of a plurality of tags to define a format for the electronic mail message in accordance with a mail markup language. A markup tag, such as the <markup> tag construct described above in the exemplary specification for a mail markup language may be used to delimit content specified using mail markup. In this regard, the MML generation unit 118 may be configured to generate an electronic mail message having content delimited by a markup tag specified using one or more tags in accordance with a mail markup language. The MML processing unit 128 may be correspondingly configured to process a received electronic mail message having content specified using one or more tags.

In a third method, content of an electronic mail message may be specified using an external source file. In this regard, a source tag, such as the <source> tag construct described above in the exemplary specification for a mail markup language, may be used to delimit a reference to an external file that is understood to comprise content of the electronic mail message based upon the source tag. In this regard, the MML processing unit 128 may be configured to parse a received electronic mail message having a source tag and in processing the electronic mail message, access the referenced source file and import content from the referenced source file.

In some embodiments when generating a new electronic mail message, the MML generation unit 118 may be configured to provide a user with an option to select one or more of the above methods for specifying content of the electronic mail message. Such option may be presented to the user over the user interface 116 and the user may make a corresponding selection. The MML generation unit 118 may then specify content for the electronic mail message based at least in part upon the user's selection.

### Specifying the Presentation of Text

Embodiments of mail markup language enable the specification of the presentation of text within an electronic mail message through the use of tags and/or attributes to tags that provide for the specification of text direction, text orientation, text wrap, and/or language of a section of text. These tags and/or attributes provide flexibility in specifying a format, such as for internationalization purposes.

In this regard, the MML generation unit 118 may be configured to receive an indication of a direction format for text content, which indicates whether the text direction is to be “left-to-right/top-to-bottom” or “right-to-left/bottom-to-top.” The MML generation unit 118 may be configured to accordingly specify a direction format for the text content using either a tag or an attribute to a tag, such as the direction attribute construct described above in the exemplary specification for a mail markup language. In this regard, if left-to-right/top-to-bottom formatting direction is specified and the text orientation is horizontal, text is oriented beginning with a first character at a left hand portion of a container for the text with each subsequent character of the text being positioned progressively to the right of the previous character, until the right limit of the container is reached, in which case the next character will be positioned at the left hand portion of the next row of text. If left-to-right/top-to-bottom formatting direction is specified and the text orientation is vertical, text is oriented beginning with a first character at a top left hand portion of a container for the text with each subsequent character of text being positioned progressively below the previous character, until a bottom of the container is reached, in which case the next character will be positioned at the top of the next column of text.

In contrast, if right-to-left/bottom-to-top formatting direction is specified and the text orientation is horizontal, text is oriented beginning with a first character at a right hand portion of a container for the text with each subsequent character of the text being positioned progressively to the left of the previous character, until the left limit of the container is reached, in which case the next character will be positioned at the right hand portion of the next row of text. If right-to-left/bottom-to-top formatting direction is specified and the text orientation is vertical, text is oriented beginning with a first character at a bottom right hand portion of a container for the text with each subsequent character of text being positioned progressively above the previous character, until a top of the container is reached, in which case the next character will be positioned at the bottom of the next column of text. The MML processing unit 128 may accordingly be configured to parse and interpret a direction format tag and/or attribute and render or otherwise publish the formatted text content based at least in part upon the direction format tag or attribute.

The MML generation unit 118 may be further configured to receive an indication of an orientation format for text content, which indicates whether the text orientation is to be “horizontal” or “vertical.” The MML generation unit 118 may be configured to accordingly specify an orientation format for the text content using either a tag or an attribute to a tag, such as the orientation attribute construct described above in the exemplary specification for a mail markup language. If horizontal orientation format is specified, then text is arranged in a series of rows. On the other hand, if vertical orientation format is specified, text is arranged in a series of vertical columns. The MML processing unit 128 may accordingly be configured to parse and interpret an orientation format tag and/or attribute and render or otherwise publish the formatted text content based at least in part upon the orientation format tag or attribute.

The MML generation unit 118 may be additionally configured to receive an indication of a wrap direction for text content, which indicates which direction lines (e.g., rows or columns) of text appear in response to existing text lines within the text container, objects, and/or other containers in the electronic mail message generated by the MML generation unit 118. In this regard, text may wrap, for example, around a graphic content (e.g., a picture) inserted into the electronic mail message. The MML generation unit 118 may be configured to accordingly specify a wrap format for the text content using either a tag or an attribute to a tag, such as the wrap attribute construct described above in the exemplary specification for a mail markup language. The wrap direction may be “standard” or “reverse.” If standard wrap direction is specified, the text will wrap below and to the right in relation to existing text lines within the text container, objects, and/or other containers. If, on the other hand reverse wrap direction is specified, the text will wrap above and to the left in relation to existing text lines within the text container, objects, and/or other containers. The MML processing unit 128 may accordingly be configured to parse and interpret a wrap format tag and/or attribute and render or otherwise publish the formatted text content based at least in part upon the wrap format tag or attribute.

The MML generation unit 118 may also be configured to receive an indication of a language format for text content, which indicates the language of the text content. The MML generation unit 118 may be configured to accordingly specify a language format for the text content using either a tag or an attribute to a tag, such as the section-language attribute construct described above in the exemplary specification for a mail markup language. The MML processing unit 128 may be configured to parse a tag and/or attribute to a tag specifying a language format for a section of text and utilize the language format definition connoted by the parsed tag and/or attribute for rendering or otherwise publishing the text content. In this regard, the language format tag and/or attribute may enable the generation of an electronic mail message having mixed languages such that the MML processing unit 128 may determine what language format is associated with a section of text when the section of text is formatted in a language differing from a default language format.

### Cite and Citation Pairing

Embodiments of mail markup language enable the linking of a citation to content of an electronic mail message through the use of tags and/or attributes to tags that provide for delimiting of cited text and citation content linked to the cited text. In this regard, the MML generation unit 118 may be configured to receive an indication that a portion of text content is a cite having a corresponding citation and content comprising the corresponding citation. The MML generation unit 118 may be configured to accordingly delimit cited text using either a tag or an attribute to a tag, such as the <cite> tag construct described above in the exemplary specification for a mail markup language. The MML generation unit 118 may be further configured to delimit the content comprising the citation using either a tag or an attribute to a tag, such as the <citation> tag construct described above in the exemplary specification for a mail markup language.

In some embodiments, the MML generation unit 118 is configured to generate a cite tag comprising an attribute referencing the corresponding citation tag, thus binding content delimited by the cite tag to content delimited by the citation tag. The MML processing unit 128 may be accordingly configured to parse cite and citation tags included in a received electronic mail message and publish the message such that the binding between content delimited by the cite tag and content delimited by the corresponding citation tag is reflected.

### Public Key Security

Embodiments of mail markup language enable dissemination of a public key in an electronic mail message. In this regard, the MML generation unit 118 may be configured to receive an electronic mail address associated with an entity and an indication of a public key associated with the entity. The indication of the public key may comprise, for example, a hash of the public key, the public key, a uniform resource identifier identifying a location from which the public key is retrievable, and/or the like. The MML generation unit 118 may be configured to generate an electronic mail message having a format specified with a hierarchy of a plurality of tags in accordance with a mail markup language. At least one of the tags may comprise a public key tag or a public key attribute delimiting the indication of the public key and binding the indication of the public key to the electronic mail address.

When the MML generation unit 118 delimits the indication of the public key with a public key tag, the public key tag may comprise a child tag of a parent tag comprising one of a to tag (e.g., the <to> tag construct described above), a copy tag (e.g., the <copy> tag construct described above), a blind-copy tag (e.g., the <blind-copy> tag construct described above, a from tag (e.g., the <from> tag construct described above), or a reply-to tag (e.g., the <reply-to> tag construct described above). The MML generation unit 118 may delimit the electronic mail address with the parent tag such that the binding between the indication of the public key and the electronic mail address is specified by the relationship between the parent tag and the public key tag in accordance with a mail markup language.

When the MML generation unit 118 delimits the indication of the public key with a public key attribute, the public key attribute may comprise an attribute of tag comprising one of a to tag (e.g., the <to> tag construct described above), a copy tag (e.g., the <copy> tag construct described above), a blind-copy tag (e.g., the <blind-copy> tag construct described above, a from tag (e.g., the <from> tag construct described above), or a reply-to tag (e.g., the <reply-to> tag construct described above). In an exemplary embodiment, the public key attribute comprises the public key attribute described above in the exemplary specification for a mail markup language. The MML generation unit 118 may delimit the electronic mail address with the tag of which the public key attribute is an attribute such that the binding between the indication of the public key and the electronic mail address is specified by the relationship between the tag and the public key attribute in accordance with a mail markup language.

The MML processing unit 128 may accordingly be configured to receive an electronic mail message having an indication of a public key embedded therein and delimited by a public key tag and/or public key attribute. The MML processing unit 128 may be further configured to parse the electronic mail message and extract the indication of the public key from the electronic mail message based at least in part upon the public key tag or public key attribute. The MML processing unit 128 may be configured to use the indication of the public key to determine the public key indicated by the indication. When the indication of the public key is delimited by a public key tag, the MML processing unit 128 may be further configured to determine the electronic mail address to which the indication of the public key is bound based at least in part upon the relationship between the public key tag and its parent tag. When the indication of the public key is delimited by a public key attribute, the MML processing unit 128 may be configured to determine the electronic mail address to which the indication of the public key is bound based at least in part upon the relationship between the public key attribute and the tag of which the public key attribute is an attribute.

The MML generation unit 118 may be configured to use a public key (e.g., a public key for which an indication of the public key has been received in a previous electronic mail message, such as when a single device includes both a MML generation unit 118 and a MML processing unit 128) to engage in encrypted electronic mail communications with the entity associated with public key. In this regard, the MML generation unit 118 may be configured to generate an electronic mail message and encrypt the electronic mail message with the public key prior to sending the electronic mail message to the electronic mail address associated with the entity (e.g., the electronic mail address with which an indication of the public key was bound in a previously received electronic mail message). When the electronic mail message is encrypted with the public key, only an entity possessing the private key associated with the public key may decrypt and process the electronic mail message and thus unless the private key has been compromised, only the intended recipient entity may decrypt and process the sent electronic mail message.

The MML processing unit 128 may be further configured to verify that a received electronic mail message originated from a trusted entity. In this regard, a received electronic mail message may comprise a digital signature generated on the electronic mail message by a sender using a private key of the sender. Since only the public key corresponding to the private key used to generate the digital signature may be used to decrypt the digital signature, the MML processing unit 128 may verify that the received electronic mail message was actually generated and/or sent by the purported sender by decrypting the digital signature using the public key of the purported sender. Verification of origin of the email address by decryption of a digital signature may be beneficial, for example, to thwart attempts by third parties to spoof a trusted email address for purposes of sending spam or viruses. Accordingly, if the MML processing unit 128 cannot verify origin of an electronic mail message, the MML processing unit 128 may be configured to not process the electronic mail message or to solicit user permission prior to processing the electronic mail message to avoid potentially infecting the receiving device 104 with a virus that may be included in an electronic mail message not having a trusted origin.

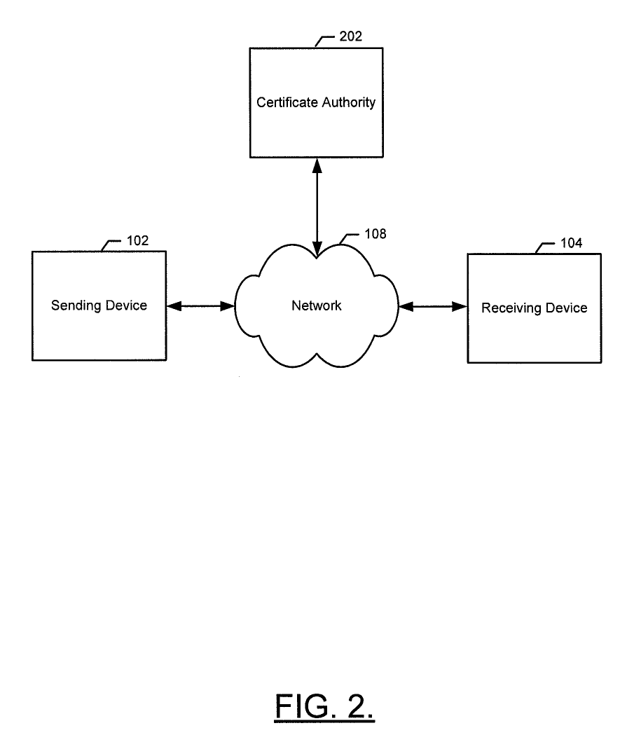

Referring now to FIG. 2, embodiments of the invention provide a system for specifying content of electronic mail messages wherein a third party certificate authority 202 is configured to verify one or more of an association between a public key and an entity or an association between a public key and an electronic mail address. In this regard, the MML processing unit 128 may be configured, for example, upon extracting an indication of a public key from a received electronic mail message, to query the certificate authority 202 to verify an association between the public key and an electronic mail address or entity. In this regard, the certificate authority 202 may be configured to issue a digital certificate binding together a public key with an electronic mail address and/or an identity of an entity. Accordingly, the MML processing unit 128 may be configured to use a digital certificate issued by the certificate authority 202 to verify an association.

### Specifying a Scope of a Head Cell Tag or Table Cell Tag in a Table

Embodiments of mail markup language enable the specification of the scope of metadata describing the content of one or more cells of a table. In this regard, the MML generation unit 118 may be configured to receive content for inclusion in one or more cells of a table and data describing the content. The MML generation unit 118 may generate an electronic mail message including the content and delimit the content within the electronic mail message using one or more tags for specifying the format of the content within the table. The MML generation unit 118 may further include the data describing the content in the electronic mail message and delimit the data using a head cell tag, such as the <head-cell> tag construct described above in the exemplary specification for a mail markup language, and/or a table cell tag, such as the <table-cell> tag construct described above in the exemplary specification for a mail markup language. The MML generation unit 118 may be further configured to specify a span-column attribute (e.g., the span-column attribute described above in the exemplary specification for a mail markup language) for a head cell tag and/or for a table cell tag that indicates a scope in terms of a number of columns that the data delimited by the head cell tag or table cell tag occupies. The MML generation unit 118 may be additionally configured to specify a span-row attribute (e.g., the span-row attribute described above in the exemplary specification for a mail markup language) for a head cell tag and/or for a table cell tag that indicates a scope in terms of a number of rows that the data delimited by the head cell tag or table cell tag occupies.

### Flowcharts According to Exemplary Embodiments of the Invention

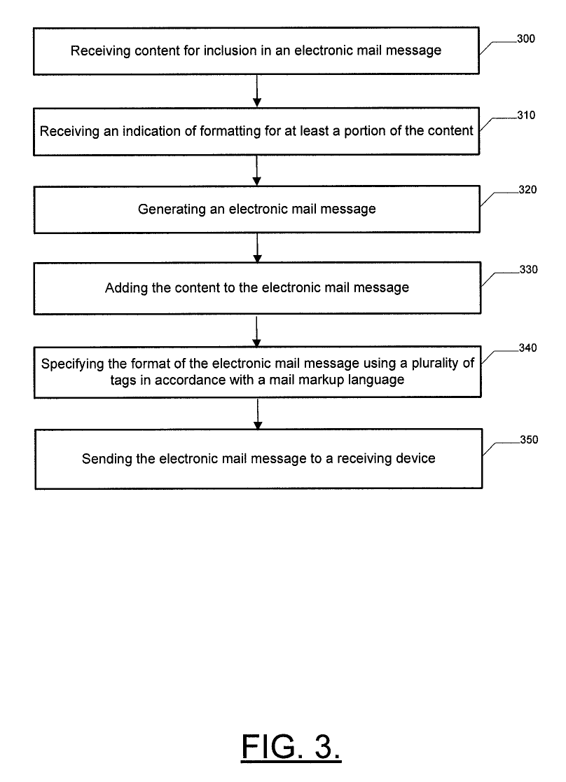

FIG. 3 illustrates a flowchart according to an exemplary method for specifying a format of an electronic mail message using a mail markup language according to an exemplary embodiment of the invention. The method may comprise the MML generation unit 118 receiving content for inclusion in the electronic mail message, at operation 300. Operation 310 comprises the MML generation unit 118 receiving an indication of formatting for at least a portion of the content. The MML generation unit 118 may then generate an electronic mail message, at operation 320. Operation 330 may comprise the MML generation unit 118 adding the received content to the electronic mail message. The MML generation unit 118 may then specify the format of the electronic mail message based at least in part upon the indication of formatting received at operation 310 using a plurality of tags in accordance with a mail markup language, at operation 340. Operation 350 may comprise the MML generation unit 118 sending the electronic mail message to a receiving device 104.

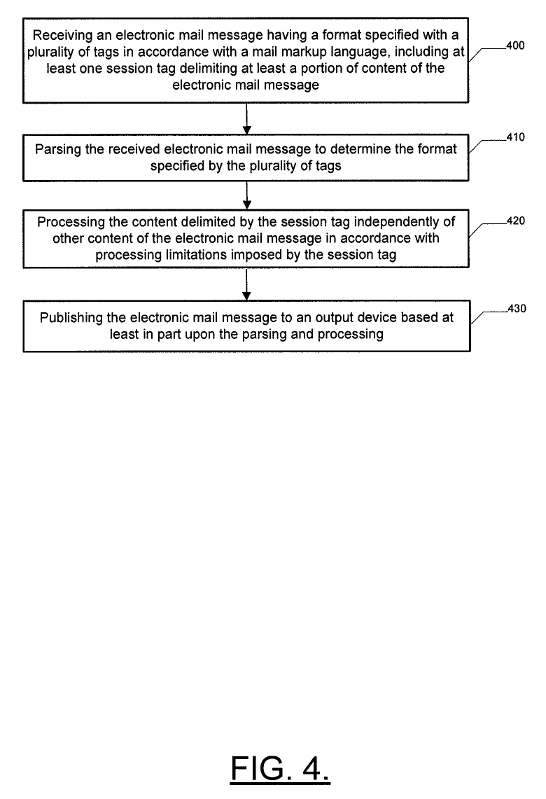

FIG. 4 illustrates a flowchart according to an exemplary method for processing an electronic mail message having a format specified in accordance with a mail markup language according to an exemplary embodiment of the invention. The method may comprise the MML processing unit 128 receiving an electronic mail message having a format specified with a plurality of tags in accordance with a mail markup language, including at least one session tag delimiting at least a portion of content of the electronic mail message, at operation 400. Operation 410 may comprise the MML processing unit 128 parsing the received electronic mail message to determine the format specified by the plurality of tags. The MML processing unit 128 may then process the content delimited by the session tag independently of other content of the electronic mail message in accordance with processing limitations imposed by the session tag, at operation 420. Operation 430 may comprise the MML processing unit 128 publishing the electronic mail message to an output device based at least in part upon the parsing and processing.

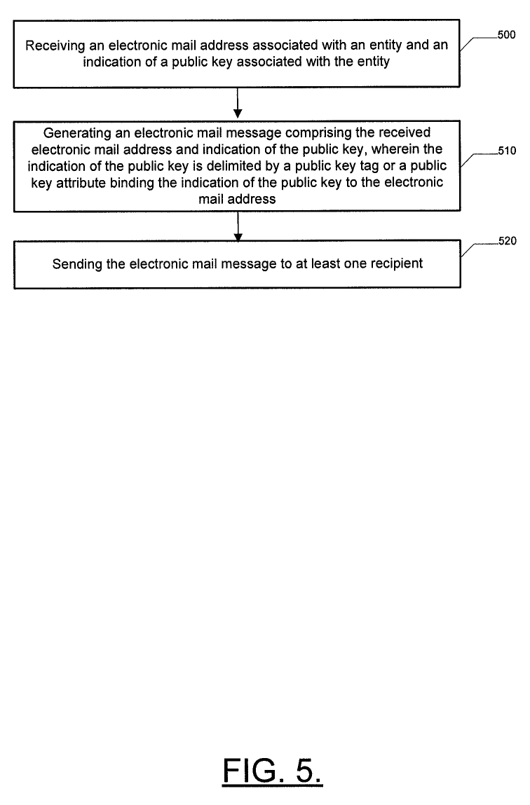

FIG. 5 illustrates a flowchart according to an exemplary method for disseminating a public key in an electronic mail message formatted in accordance with a mail markup language according to an exemplary embodiment of the invention. The method may comprise the MML generation unit 118 receiving an electronic mail address associated with an entity and an indication of a public key associated with the entity, at operation 500. Operation 510 may comprise the MML generation unit 118 generating an electronic mail message comprising the received electronic mail address and indication of the public key, wherein the indication of the public key is delimited by a public key tag or a public key attribute binding the indication of the public key to the electronic mail address. The MML generation unit 118 may then send the electronic mail message to at least one recipient, at operation 520.

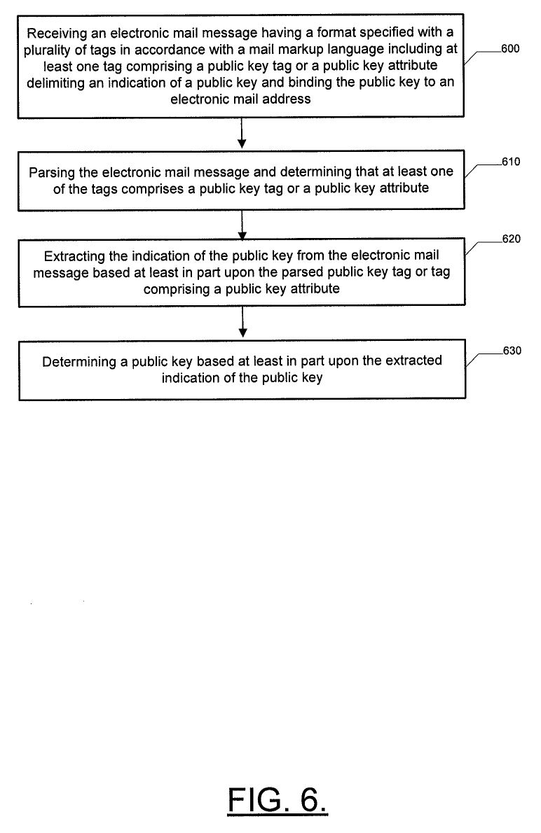

FIG. 6 illustrates a flowchart according to an exemplary method for receiving an indication of a public key in an electronic mail message formatted in accordance with a mail markup language according to an exemplary embodiment of the invention. The method may comprise the MML processing unit 128 receiving an electronic mail message having a format specified with a plurality of tags in accordance with a mail markup language including at least one tag comprising a public key tag or a public key attribute delimiting an indication of a public key and binding the public key to an electronic mail address, at operation 600. Operation 610 may comprise the MML processing unit 128 parsing the electronic mail message and determining that at least one of the tags comprises a public key tag or a public key attribute. The MML processing unit 128 may then extract the indication of the public key from the electronic mail message based at least in part upon the parsed public key tag or tag comprising a public key attribute, at operation 620. Operation 630 may then comprise the MML processing unit 128 determining a public key based at least in part upon the extracted indication of the public key.

FIGS. 3-6 are flowcharts of a system, method, and computer program product according to exemplary embodiments of the invention. It will be understood that each block or step of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions and combinations of steps for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. Embodiments of the invention provide a mail markup language tailored to the electronic mail medium that may enable users to fully specify rich formatting for an electronic mail message. Embodiments of the invention further provide methods, apparatuses, and computer program products for sending and receiving electronic mail messages with a format specified in accordance with a mail markup language.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for specifying a format of an electronic mail message using a mail markup language, the method comprising:
receiving content for inclusion in the electronic mail message;
receiving an indication of formatting for at least a portion of the content;
adding the received content to the electronic mail message; and
specifying, with a mail markup language generation unit, the format of the electronic mail message based at least in part upon the received indication of formatting using a plurality of tags in accordance with the mail markup language, wherein at least one of the tags comprises a session tag delimiting a portion of the content and imposing processing limitations on a recipient of the electronic mail message such that the recipient must process content delimited by the session tag independently of other content of the electronic mail message.

2. The method of claim 1, wherein:
receiving an indication of formatting for at least a portion of the content comprises receiving an indication of a stylesheet for at least a portion of the content; and
specifying the format of the electronic mail message further comprises applying the stylesheet to content delimited by the session tag; and
wherein the imposed processing limitations include a limitation that the recipient must apply the stylesheet only to content delimited by the session tag.

3. The method of claim 1, wherein:
receiving content for inclusion in the electronic mail message comprises receiving a first content from a first author and a second content from a second author;
receiving an indication of formatting for at least a portion of the content comprises receiving an indication associated with the first content and an indication associated with the second content; and
wherein the tags comprise a first session tag delimiting the first content and a second session tag delimiting the second content, the first and second session tags imposing processing limitations on the recipient such that the recipient must process the first content and second content independently of each other and independently of any other content of the electronic mail message.

4. The method of claim 1, wherein:
receiving content for inclusion in the electronic mail message comprises receiving a collection of a plurality of files having a common Multipurpose Internet Mail Extension type; and
wherein one of the tags comprises a collection tag functioning as a container for the plurality of files such that only a single multipurpose internet mail extension is defined for the entire collection of the plurality of files.

5. The method of claim 1, wherein:
receiving content for inclusion in the electronic mail message comprises receiving an indication of a public key associated with an entity; and
wherein one of the tags comprises a public key attribute or a public key tag delimiting the indication of the public key and binding the indication of the public key to an electronic mail address for the associated entity.

6. An apparatus for specifying a format of an electronic mail message using a mail markup language, the apparatus comprising a processor configured to:
receive content for inclusion in the electronic mail message;
receive an indication of formatting for at least a portion of the content;
add the received content to the electronic mail message; and
specify the format of the electronic mail message based at least in part upon the received indication of formatting using a plurality of tags in accordance with the mail markup language, wherein at least one of the tags comprises a session tag delimiting a portion of the content and imposing processing limitations on a recipient of the electronic mail message such that the recipient must process content delimited by the session tag independently of other content of the electronic mail message.

7. The apparatus of claim 6, wherein the processor is configured to:
receive an indication of formatting for at least a portion of the content by receiving an indication of a stylesheet for at least a portion of the content; and
specify the format of the electronic mail message by applying the stylesheet to content delimited by the session tag; and
wherein the imposed processing limitations include a limitation that the recipient must apply the stylesheet only to content delimited by the session tag.

8. The apparatus of claim 6, wherein the processor is configured to:
receive content for inclusion in the electronic mail message by receiving a first content from a first author and a second content from a second author;
receive an indication of formatting for at least a portion of the content by receiving an indication associated with the first content and an indication associated with the second content; and
wherein the tags comprise a first session tag delimiting the first content and a second session tag delimiting the second content, the first and second session tags imposing processing limitations on the recipient such that the recipient must process the first content and second content independently of each other and independently of any other content of the electronic mail message.

9. The apparatus of claim 6, wherein the processor is configured to:
receive content for inclusion in the electronic mail message by receiving a collection of a plurality of files having a common Multipurpose Internet Mail Extension type; and
wherein one of the tags comprises a collection tag functioning as a container for the plurality of files such that only a single multipurpose internet mail extension is defined for the entire collection of the plurality of files.

10. The apparatus of claim 6, wherein the processor is configured to:
receive content for inclusion in the electronic mail message by receiving an indication of a public key associated with an entity; and
wherein one of the tags comprises a public key attribute or a public key tag delimiting the indication of the public key and binding the indication of the public key to an electronic mail address for the associated entity.

11. A method for processing an electronic mail having a format specified in accordance with a mail markup language, the method comprising:
receiving an electronic mail message having a format specified with a plurality of tags in accordance with the mail markup language, wherein at least one of the tags comprises a session tag delimiting a portion of the content and imposing processing limitations such that the content delimited by the session tag must be processed independently of other content of the electronic mail message;
parsing the received electronic mail message to determine the format specified by the plurality of tags; and
processing, with a mail markup language processing unit, the content delimited by the session tag independently of other content of the electronic mail message in accordance with the processing limitations imposed by the session tag.

12. The method of claim 11, wherein the received electronic mail message specifies a stylesheet for content delimited by the session tag; and
wherein processing the content delimited by the session tag comprises applying the stylesheet only to content delimited by the session tag based at least in part upon limitations imposed by the session tag.

13. The method of claim 11, wherein the tags comprise a first session tag delimiting first content provided by a first author and a second session tag delimiting second content provided by a second author, the first and second session tags imposing processing limitations on such that the processor must process the first content and second content independently of each other and independently of any other content of the electronic mail message; and
wherein processing the content comprises processing the first content and second content independently of each other and independently of any other content of the electronic mail message in accordance with the processing limitations imposed by the session tags.

14. The method of claim 11, further comprising publishing a representation of the electronic mail message on an output device in accordance with the format specified by the plurality of tags based at least in part upon the parsing and processing.

15. An apparatus for processing an electronic mail message having a format specified in accordance with a mail markup language, the apparatus comprising a processor configured to:
cause an electronic mail message to be received, the electronic mail message having a format specified with a plurality of tags in accordance with the mail markup language, wherein at least one of the tags comprises a session tag delimiting a portion of the content and imposing processing limitations such that the processor must process content delimited by the session tag independently of other content of the electronic mail message;
parse the received electronic mail message to determine the format specified by the plurality of tags; and
process the content delimited by the session tag independently of other content of the electronic mail message in accordance with the processing limitations imposed by the session tag.

16. The apparatus of claim 15, wherein the received electronic mail message specifies a stylesheet for content delimited by the session tag; and
wherein the processor is configured to process the content delimited by the session tag by applying the stylesheet only to content delimited by the session tag based at least in part upon limitations imposed by the session tag.

17. The apparatus of claim 15, wherein the tags comprise a first session tag delimiting first content provided by a first author and a second session tag delimiting second content provided by a second author, the first and second session tags imposing processing limitations on the recipient such that the processor must process the first content and second content independently of each other and independently of any other content of the electronic mail message; and
wherein processing the content comprises processing the first content and second content independently of each other and independently of any other content of the electronic mail message in accordance with the processing limitations imposed by the session tags.

18. The apparatus of claim 15, further comprising an output device, wherein the processor is further configured to cause a representation of the electronic mail message to be published to the display in accordance with the format specified by the plurality of tags based at least in part upon the parsing and processing.

19. A method for disseminating a public key in an electronic mail message formatted in accordance with a mail markup language, the method comprising:
receiving an electronic mail address associated with an entity and an indication of a public key associated with the entity;
generating, with a mail markup language generation unit, an electronic mail message comprising the received electronic mail address and indication of the public key by specifying a format of the electronic mail message using a plurality of tags in accordance with the mail markup language, wherein at least one of the tags comprises a public key tag or a public key attribute delimiting the indication of the public key and binding the indication of the public key to the electronic mail address; and
sending the electronic mail message to at least one recipient.

20. The method of claim 19, wherein:
when the indication of the public key is delimited by a public key tag, the public key tag comprises a child tag of a parent tag comprising one of a to tag, copy tag, blind-copy tag, from tag, or reply-to tag, and wherein the parent tag delimits the electronic mail address such that the binding between the indication of the public key and the electronic mail address is specified by the relationship between the parent tag and the public key tag in accordance with the mail markup language; and
when the indication of the public key is delimited by a public key attribute, the public key attribute comprises an attribute of one of a to tag, copy tag, blind-copy tag, from tag, or reply-to tag, and wherein the one of the to tag, copy tag, blind-copy tag, from tag, or reply-to tag delimits the electronic mail address such that the binding between the indication of the public key and the electronic mail address is specified by the relationship between the one of the to tag, copy tag, blind-copy tag, from tag, or reply-to tag and the public key attribute in accordance with the mail markup language.

21. The method of claim 19, wherein one or more of the association between the public key and the entity or an association between the public key and the electronic mail address is verifiable with assistance from a Certificate Authority.

22. An apparatus for disseminating a public key in an electronic mail message formatted in accordance with a mail markup language, the apparatus comprising a processor configured to:
receive an electronic mail address associated with an entity and an indication of a public key associated with the entity;
generate an electronic mail message comprising the received electronic mail address and indication of the public key by specifying a format of the electronic mail message using a plurality of tags in accordance with the mail markup language, wherein at least one of the tags comprises a public key tag or a public key attribute delimiting the indication of the public key and binding the indication of the public key to the electronic mail address; and
cause the electronic mail message to be sent to at least one recipient.

23. The apparatus of claim 22, wherein:
when the indication of the public key is delimited by a public key tag, the public key tag comprises a child tag of a parent tag comprising one of a to tag, copy tag, blind-copy tag, from tag, or reply-to tag, and wherein the parent tag delimits the electronic mail address such that the binding between the indication of the public key and the electronic mail address is specified by the relationship between the parent tag and the public key tag in accordance with the mail markup language; and
when the indication of the public key is delimited by a public key attribute, the public key attribute comprises an attribute of one of a to tag, copy tag, blind-copy tag, from tag, or reply-to tag, and wherein the one of the to tag, copy tag, blind-copy tag, from tag, or reply-to tag delimits the electronic mail address such that the binding between the indication of the public key and the electronic mail address is specified by the relationship between the one of the to tag, copy tag, blind-copy tag, from tag, or reply-to tag and the public key attribute in accordance with the mail markup language.

24. A method for receiving an indication public key in an electronic mail message formatted in accordance with a mail markup language, the method comprising:
receiving, at a receiving device, an electronic mail message having a format specified with a plurality of tags in accordance with the mail markup language, wherein at least one of the tags comprises a public key tag or a public key attribute delimiting an indication of the public key and binding the public key to an electronic mail address; and
extracting, with a mail markup language processing unit, the indication of the public key from the electronic mail message based at least in part upon the public key tag or the public key attribute.

25. The method of claim 24, wherein:
when the indication of the public key is delimited by a public key tag, the public key tag comprises a child tag of a parent tag comprising one of a to tag, copy tag, blind-copy tag, from tag, or reply-to tag, and wherein the parent tag delimits the electronic mail address such that the binding between the indication of the public key and the electronic mail address is specified by the relationship between the parent tag and the public key tag in accordance with the mail markup language; and
when the indication of the public key is delimited by a public key attribute, the public key attribute comprises an attribute of one of a to tag, copy tag, blind-copy tag, from tag, or reply-to tag, and wherein the one of the to tag, copy tag, blind-copy tag, from tag, or reply-to tag delimits the electronic mail address such that the binding between the indication of the public key and the electronic mail address is specified by the relationship between the one of the to tag, copy tag, blind-copy tag, from tag, or reply-to tag and the public key attribute in accordance with the mail markup language.

26. The method of claim 24, further comprising using the public key to engage in encrypted electronic mail communications with an entity associated with the public key.

27. An apparatus for receiving an indication of a public key in an electronic mail message formatted in accordance with a mail markup language, the apparatus comprising a processor configured to:
cause an electronic mail message to be received, the electronic mail message having a format specified with a plurality of tags in accordance with the mail markup language, wherein at least one of the tags comprises a public key tag or a public key attribute delimiting an indication of the public key and binding the public key to an electronic mail address; and
extract the indication of the public key from the electronic mail message based at least in part upon the public key tag or the public key attribute.

28. The apparatus of claim 27, wherein:
when the indication of the public key is delimited by a public key tag, the public key tag comprises a child tag of a parent tag comprising one of a to tag, copy tag, blind-copy tag, from tag, or reply-to tag, and wherein the parent tag delimits the electronic mail address such that the binding between the indication of the public key and the electronic mail address is specified by the relationship between the parent tag and the public key tag in accordance with the mail markup language; and
when the indication of the public key is delimited by a public key attribute, the public key attribute comprises an attribute of one of a to tag, copy tag, blind-copy tag, from tag, or reply-to tag, and wherein the one of the to tag, copy tag, blind-copy tag, from tag, or reply-to tag delimits the electronic mail address such that the binding between the indication of the public key and the electronic mail address is specified by the relationship between the one of the to tag, copy tag, blind-copy tag, from tag, or reply-to tag and the public key attribute in accordance with the mail markup language.

29. The apparatus of claim 27, wherein the processor is further configured to use the public key to engage in encrypted electronic mail communications with an entity associated with the public key.
